(19) United States
(12) Patent Application Publication
(10) Pub. No.: US 2013/0097135 A1
(43) Pub. Date: Apr. 18, 2013

(54) METHOD AND SYSTEM FOR GENERATING DOMAIN SPECIFIC IN-MEMORY DATABASE MANAGEMENT SYSTEM

(71) Applicant: PIE DIGITAL, Inc., Palo Alto, CA (US)

(72) Inventor: Robert N. GOLDBERG, Emerald Hills, CA (US)

(73) Assignee: PIE DIGITAL, INC., Palo Alto, CA (US)

(21) Appl. No.: 13/653,126

(22) Filed: Oct. 16, 2012

Related U.S. Application Data
(60) Provisional application No. 61/548,142, filed on Oct. 17, 2011.

(51) Int. Cl. G06F 7/00; G06F 17/30

(52) U.S. Cl. 707/704; 707/798; 707/E17.007; 707/E17.044

(57) ABSTRACT

A concurrent graph DBMS allows for representation of graph data structures in memory, using familiar Java object navigation, while at the same time providing atomicity, consistently, and transaction isolation properties of a DBMS, including concurrent access and modification of the data structure from multiple application threads. The concurrent graph DBMS serves as a “traffic cop” between application threads to prevent them from seeing unfinished and inconsistent changes made by other threads, and atomicity of changes. The concurrent graph DBMS provides automatic detection of deadlocks and correct rollback of a thread's incomplete transaction when exceptions or deadlocks occur. The concurrent graph DBMS may be generated from a schema description specifying objects and relationships between objects, for the concurrent graph DBMS.

### CROSS-REFERENCE TO RELATED APPLICATIONS

This application claims priority to U.S. Provisional Patent Application Ser. No. 61/548,142 filed Oct. 17, 2011, entitled “Concurrent Graph In-Memory DBMS and Automatic Generation of Concurrent Graph In-Memory DBMS,” which is hereby incorporated herein by reference.

### BACKGROUND

1. Field

Embodiments of the invention generally relate to computing applications. More specifically, embodiments provide a multi-threaded application with an in-memory database management system (DBMS) using a collection of automatically generated programming objects.

2. Description of the Related Art

A broad variety of computer software applications access data stored in databases. Similarly, application programs often create and manipulate complex graph data structures in order to perform a variety of application functions. Typically, a program developer creates such data structures from objected oriented programming objects, e.g., a Java® programming language or a C++ class. Using the Java programming language as an example, a developer may compose a collection of “plain old Java objects,” where references between objects in the graph data structure are represented as Java object variables that point to other Java objects. However, this approach is not thread safe. In some cases, thread safety can be achieved by using, e.g., synchronization mechanisms provided by the Java programming language on a “root” object of a complex data structure. But doing so limits the throughput of a multithreaded program which makes frequent access to the data structure. More fine-grained locking can be used on the data structure, e.g., by using separate locks on separate elements, but this approach introduces the possibility of deadlock conditions. More generally, Java thread synchronization does not address transactions, automatic deadlock detection and rollback, or two-level locking.

Another solution to providing a multithreaded application with access to data is to forego use of a graph data structure objects and instead to configure each thread to access another application, typically a relational database. In such a case, an application program typically uses some form of object-relational mapping mechanism to map data records stored in a relational database to attributes of program objects as well as to provide independent access to data from each thread. The relational database coordinates multiple threads accessing the data. However, DBMS's are frequently much slower for write-accesses and thus are suited to applications that are read-mostly, rather than applications that make heavy using of writing (changing) the graph data structure from multiple threads.

### SUMMARY

Embodiments presented herein include a method for generating source code for a concurrent graph in-memory database management system (DBMS). This method may generally include receiving a schema description of a concurrent graph data structure. The schema description specifies one or more concurrent object classes, relationships among the one or more object classes, and at least a primary key used to identify instance of each of the one or more object classes. This method may further include generating, for each of the one or more concurrent object classes, source code implementing the one or more concurrent object class as specified by the schema description and further include generating, for the concurrent graph data structure, source code implementing an object factory class. The object factory class is configured to instantiate instances of the one or more object classes in response to requests from a thread in the multithreaded application and also include generating, for the in-memory DBMS, source code to provide concurrency control to each instance of the one or more object classes instantiated by the object factory in the concurrent graph data structure.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings. Note, however, the appended drawings illustrate only typical embodiments of this invention and do not limit the scope thereof, for the invention may admit to other equally effective embodiments.

FIG. 1 illustrates an example multithreaded application which includes an in-memory DBMS provided by a concurrent graph data structure, according to one embodiment.

FIG. 2 illustrates an example of generated source code classes for an in-memory DBMS generated from an application specific data schema 205, according to one embodiment.

FIG. 3 illustrates an example of an application specific data schema, according to one embodiment.

FIG. 4 illustrates an example class structure for a concurrent graph generated from the schema description of FIG. 3, according to one embodiment.

FIG. 5 further illustrates an example of a concurrent graph data structure used to provide an in-memory DBMS accessed by a multithreaded application, according to one embodiment.

FIG. 6 further illustrates relationships between objects in the concurrent graph data structure and locks obtained by application thread performing a transaction, according to one embodiment.

FIG. 7 illustrates a method for generating source code for an in-memory DBMS from an application specific data schema, according to one embodiment.

FIG. 8 illustrates a method for performing transactions against an in-memory DBMS, according to one embodiment.

FIG. 9 illustrates an example computing system configured with a concurrent graph data structure, according to one embodiment.

### DETAILED DESCRIPTION

Embodiments presented herein provide an object-oriented, multithreaded application program that both supports a specific object-schema and provides transactional semantics for threads launched by the application to access a concurrent graph data structure, which itself provides an in-memory DBMS for the application threads. Embodiments presented herein also provide techniques for generating source code for the concurrent graph data structure, transaction patterns for accessing the concurrent graph data structure, as well as source code for creating, reading and updating, and deleting attributes for objects in the graph structure. At the same time, the generated code handles concurrency issues and deadlocks that occur when multiple threads access the concurrent graph data structure.

In one embodiment, the generated code includes a factory class used to instantiate objects (i.e., nodes) in the concurrent graph data structure, manage indexes of objects in the concurrent graph, and resolve deadlocks that may occur when multiple threads access the concurrent graph simultaneously. The resulting application code allows a multithreaded program to access the graph data structure quickly and efficiently, including performing frequent writes (changes) to the concurrent graph data structure, as well as frequent reading of the concurrent graph, from multiple threads executing simultaneously.

In one embodiment, the concurrent graph data structure incorporates functionality of a conventional DBMS into the implementation of a set of programmatic objects (e.g., Java or C++ classes) accessed by a multithreaded application, by using encapsulation. For example, the concurrent graph data structure may manage concurrency issues, e.g., using two-level locking or after-the-fact optimistic concurrency detection, deadlock detection (if pessimistic concurrency is used), rollback of incomplete transactions (in case of rollback due to concurrency violations, deadlock, or Java exceptions interrupting a transaction), without requiring a developer to explicitly build this functionality into the multithreaded application or concurrent graph objects. Instead, the source code generated from a schema description in conjunction with the use of transaction annotation in the application itself encapsulates this functionality into the objects of the concurrent graph structure.

The generated code may include a factory object for creating instances of the concurrent graph objects. The factory object may also include an extent or realized collection of all instances of each class of object in the concurrent graph data structure, and indexes on the objects in an extent based on an extensible set of unique keys for each object. In one embodiment, the code generation tools described herein automatically generate an implementation of the objects that make up the concurrent graph data structure from a high level data schema language that describes the objects and relationships as well as the factory from the same high level data schema language. The schema language allows a developer to represent relationships between objects explicitly, including the cardinality of the relationship, and relationships may be modified from either of the two objects that have the relationship, and both ends of the relationship are automatically maintained consistently by objects of the concurrent graph. In one embodiment, the two-way relationship maintenance is encapsulated within the implementation of the objects created by the code generator for a given data schema defined using the data schema language.

The concurrent graph data structure, i.e., the in-memory DBMS, allows for representation of graph data structures in memory using familiar object navigation semantics, while at the same time providing the atomicity, concurrency and integrity properties of a conventional DBMS, including concurrent access and modification of the concurrent graph data structure from multiple threads. Thus, the concurrent graph data structure serves as a “traffic cop” between multiple application threads, preventing them from seeing unfinished and inconsistent changes made by other threads performing transactions against the concurrent graph, and atomicity of changes. It also provides automatic detection of deadlocks, and corrects rollback of a thread's incomplete transaction when exceptions or deadlocks occur.

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet.

Note, embodiments of the invention are described below using the Java programming language as an example of a programming language used to provide source code for an in-memory DBMS using a concurrent graph data structure. One of ordinary skill in the art will recognize, however, that embodiments of the invention may be adapted for use with other object oriented programming languages that support multithreaded applications.

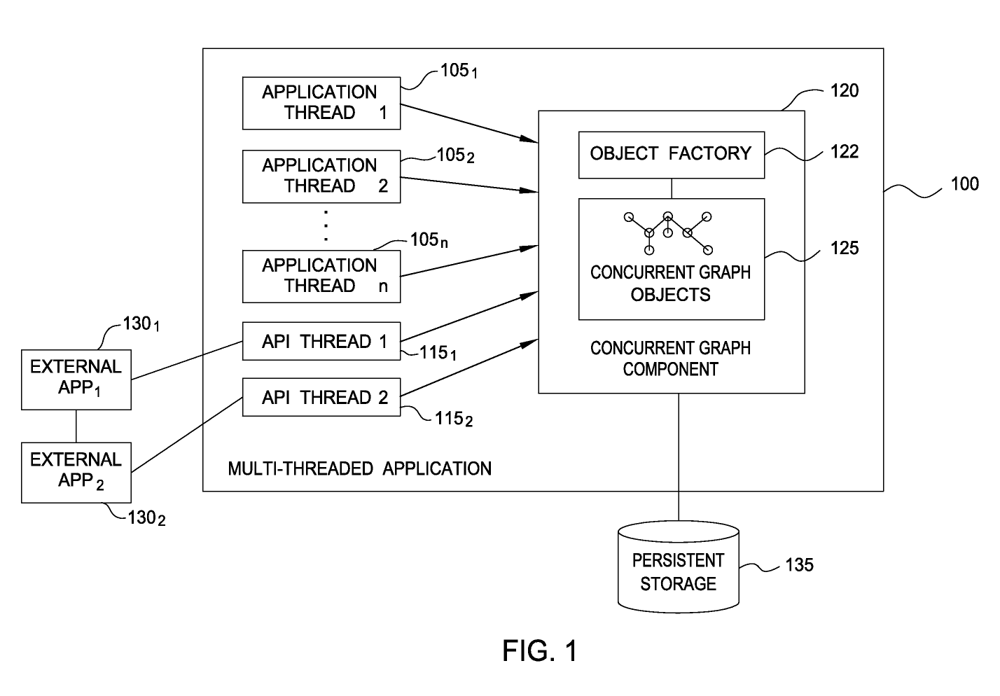

FIG. 1 illustrates an example multithreaded application 100 which includes an in-memory DBMS provided by a concurrent graph data structure 120, according to one embodiment. As shown, the multithreaded application 100 includes application threads 105₁₋ₙ and API threads 115₁₋₂. Each thread 105 and 115 provides a unit of execution within the multithreaded application 100. For example, the Java Virtual Machine allows an application to have multiple threads of execution running concurrently. In this example, application threads 105₁₋ₙ access the concurrent graph data structure 120 as part of executing application 100 and API threads 115₁₋₂ access the concurrent graph data structure 120 in response to requests made by external applications 130₁₋₂. The API threads 130 allow separate processes or applications to access the concurrent graph data structure 120 using an interface defined by an API. As shown, API thread 115₁ access concurrent graph data structure 120 in response to messages from external application 130₁ and API thread 115₂ accesses concurrent graph data 120 structure in response to messages from external applications 130₂. Of course, the number of simultaneous threads launched by application 100, and the capabilities exported to external applications 130 by API threads 115 may be tailored to suit the needs of a particular case.

In one embodiment, the application threads 105₁₋ₙ and API threads 115₁₋₂ initiate and commit transactions against the concurrent graph data structure 120, e.g., threads 105, 115 may create, read, updated and delete data elements (i.e., objects and attributes of objects) in the concurrent graph data structure 120. In turn, the concurrent graph data structure 120 may be configured to ensure that transactions performed concurrently by multiple threads are (i) atomic, i.e., a transaction initiated by a thread 105, 115 is either completed fully or not at all, including rolling back a partially completed transaction; (ii) consistent, i.e., any completed transaction will bring the database from one valid state to another, e.g., deleting a parent object will result in any child objects being deleted as well; and (iii) isolated, i.e., two threads executing independent transactions concurrently results in a concurrent graph data structure that could have been obtained if transactions are executed one after the other.

As shown, the concurrent graph data structure 120 includes an object factory 122 and concurrent graph objects 125. In one embodiment, the object factory provides a programmatic object configured to create the nodes (i.e., instantiate a concurrent graph object 122) as part of transactions initiated by threads 105, 115. More generally, the concurrent graph data structure 120, or just concurrent graph, provides an in-memory data structure which includes object instances (i.e., concurrent graph objects 125) and relationships among object instances. Unlike conventional object-oriented programming objects, the concurrent graph object 120 includes a locking mechanism to prevent an object's state from being simultaneously modified by two different threads 105, 115 at the same time and also includes a rollback mechanism allowing object state to be restored to a value it had at the start of a transaction (if the transaction fails).

In one embodiment, the concurrent graph data structure 120 includes a mechanism to determine which object instances (i.e., which concurrent graph objects 125) have been read and/or modified by a given transaction. Additionally, the locking mechanism of the concurrent graph data structure 120 is able to determine when a deadlock occurs, e.g., when two threads are each waiting for access to a lock held by the other. In one embodiment, the concurrent graph data structure 120 may be persisted, i.e., stored in a persistent storage medium, e.g. a disk drive. Doing so allows the in-memory state of the concurrent graphs objects 125 to be persisted to storage 135—and later read from storage 135.

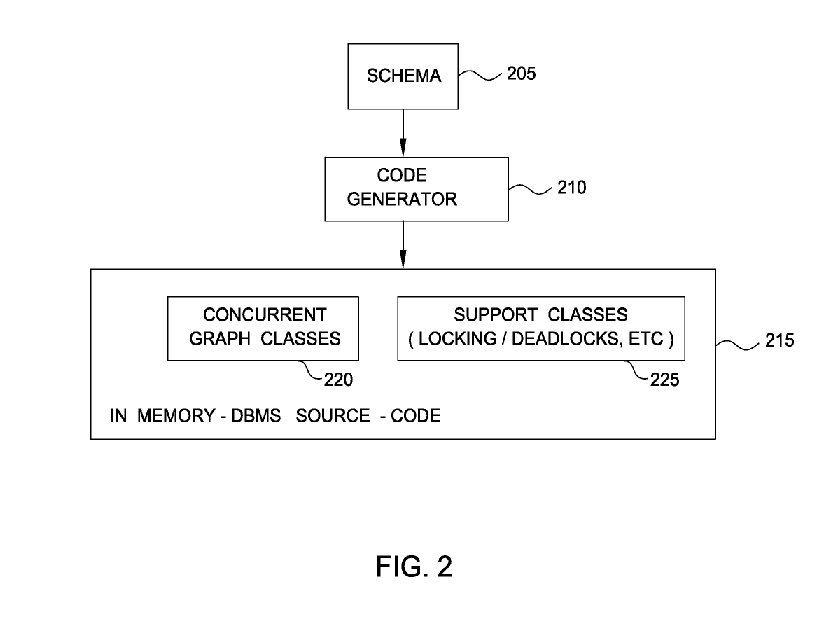

FIG. 2 illustrates an example of generated source code classes for an in-memory DBMS generated from an application specific data schema 205, according to one embodiment. As shown, in-memory DBMS generated source source code 215 includes concurrent graph classes 220 and support classes 225. The concurrent graph classes 220 include the object factory for creating objects in the concurrent graph data structure as well as classes for the objects themselves. The support classes 225 may provide the DBMS functions for objects in the concurrent graph. For example, the support classes 225 may include classes for creating indexes for concurrent graph objects, classes for creating and managing two level locks (i.e., a read/write lock) for objects in the concurrent graph, and classes for persisting (and restoring) the concurrent graph from storage. Of course, the support classes may include classes that provide a variety of additional functionally (or supporting functions) for the concurrent graph data structure.

In one embodiment, a code generator 210 may generate the in-memory DBMS source code 215 based on a schema description 205 of the entities (e.g., objects) in a given concurrent graph. The schema itself 205 may be composed according to a schema definition language used to describe concurrent objects and relationships among them including various relationship cardinalities. The code generator 210 may be configured to transform a given concurrent graph schema (e.g., schema 205) defined using the schema definition language into fully implemented objects that use a collection of inheritable base classes and a factory class (i.e.. the concurrent graph classes 220) that performs basic CRUD (create, retrieve, update, and delete) operations on the concurrent graph objects as part of thread-initiated transactions.

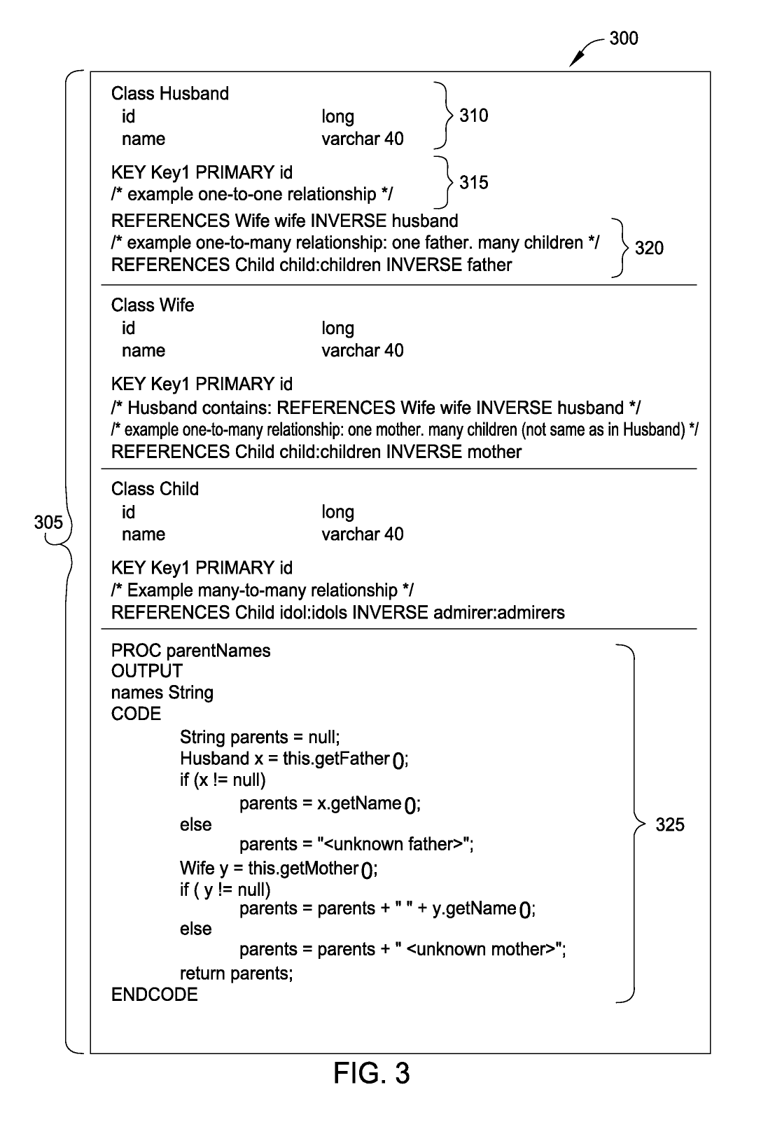

While the syntax and semantics of the schema description language may be tailored to suit the needs of a particular case, FIG. 3 illustrates an example of an application specific data schema 300, according to one embodiment. As shown, each class element 305 corresponds to an object class, instances of which may be created in the concurrent graph. In this example, the schema 300 includes a husband class, a wife class, and a child class. Each class 305 specifies data attributes each instance of a class will have when instantiated and added to the concurrent graph. For example, the husband class specifies that instances of this class include an ID (defined as a long integer variable) and a name (defined as a 40 character string). In addition to object attributes, however, data schema 300 also specifies a one or more primary keys 315 or attributes used to uniquely identify a given instance of the “husband” class in the concurrent graph. Further, data schema 300 also specifies relationships between the “husband” class and other classes in data schema 300.

More generally, the data schema 300 includes not only each object's attributes, but also includes relationships, constraints on the attributes and relationships, a declaration of unique keys, and methods that manipulate the objects. For the purposes of identifying the object, each class has a primary key. In addition, the object may have other unique keys by which an object possessing a particular key value may be found using the factory class generated for a given data schema.

Relationships between classes in the schema may specify a cardinality of that relationship (e.g., as being one-to-one, one-to-many, many-to-one, or many-to-many). Relationships among objects are bi-directional, meaning that if class A has a relationship to class B, then class B will have a corresponding inverse relationship to class A. Each direction of a relationship can be single-valued (one) or multi-valued (many). A relationship may exist between objects of two distinct classes, or between a class and itself. For example, in data schema 300, there is a one-to-one relationship between Husband and Wife. To generate source code for this relationship, the code generator may represent this one-to-one relationship using one-way Java object references on each side of the relationship, whose name indicates the relationship from that side. The bi-directional relationship between Husband and Wife is an example one-to-one relationship. Note that the relationship is declared only on one side in data schema 300 data (as shown in FIG. 3, the relationship is declared in the husband class). From Husband, the relationship is navigated as wife, and from Wife, the relationship is navigated as husband. The relationship is one-to-one.

One-to-many relationships from an object to multiple other objects may be represented with a set of Java object references from the “one” side class to the many side class and a single Java object reference from the many side to the one side class. The bi-directional relationships between Husband and Child and the separate relationship between Wife and Child are two examples of one-to-many relationships. Many-to-many relationships between an object and another object may be represented by a set of Java object references in each class. The bi-directional relationship between two Child instances (idol/admirer) is an example of a many-to-many relationship. Specifically, a Child may idolize multiple other children, and a Child may have multiple other children as admirers (note, at least as defined in this example, a child may admire him or herself).

By including the relationships, cardinality, and other constraints on relationships between objects in the data schema 300, the code generator can create source code for classes that support transactional semantics for multiple threads accessing the concurrent graph data structure. Further, in addition to specifying data attributes, the data schema 300 may also specify method operations for a particular class. For example, the “child” class of data schema 300 includes a “parentNames” procedure that returns the names of each parent associated with a child instance. Note, to do so, an instance of a child class in the concurrent graph data structure must traverse the relationships of that child object to identify the parent names from the related objects in the concurrent graph data structure. To do so, the generated code may automatically obtain read locks when a thread accesses the concurrent graph using this method. Doing so allows the developer to simply access the concurrent graph data structure using familiar object oriented mechanisms, without having to explicitly address concurrency, atomicity, or deadlock resolution into the application. Note, in addition to any specific methods supplied in the data schema 300, the code generator may also create accessor and mutator methods for the data attributes of each class, e.g., methods to perform create, read, update and delegate operations for attributes of an object defined by data schema 300.

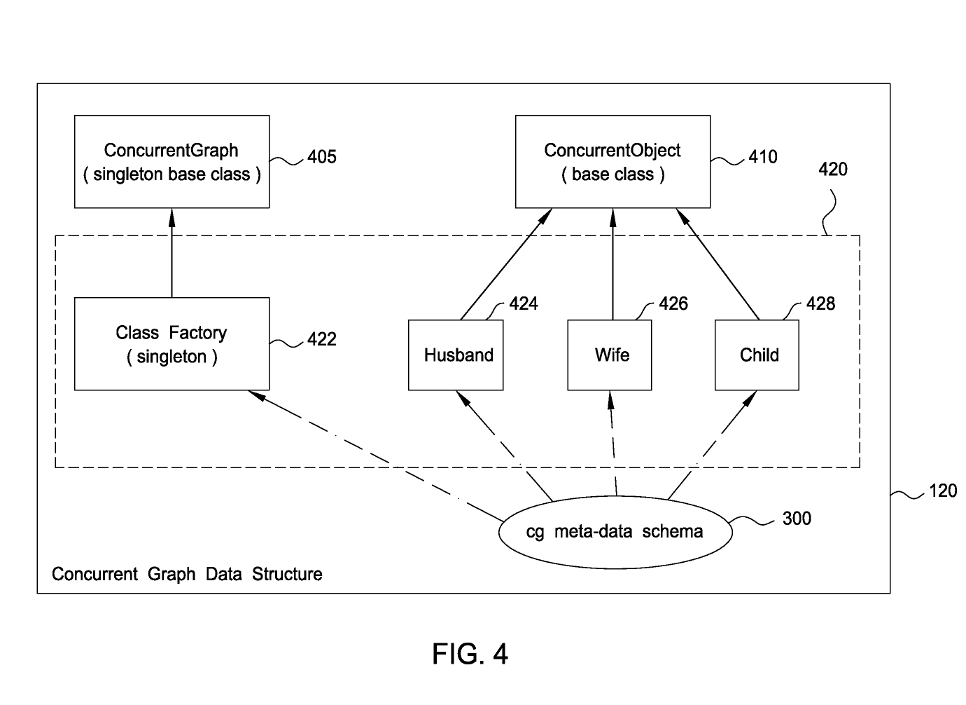

FIG. 4 illustrates an example class structure for a concurrent graph data structure 120 generated from the data schema 300 of FIG. 3, according to one embodiment. As shown, a set of generated classes 420 include a class factory 422, a husband class 424, a wife class 426, and a child class 428. In this embodiment, the generated classes 420 depend on the particular metadata schema 300. Additionally, the class factory 422 is derived from a concurrent graph base class 405 and the data classes are each derived from a concurrent object base class—as represented by solid arrows in FIG. 4. The concurrent graph base class 405 encapsulates the functionality needed to create an instance of the concurrent graph data structure 120 inherited by the class factory 422, i.e., class factory 422 inherits the functionality needed to create an in-memory database accessed by multiple threads of a multithreaded application, as well as create instances of the concurrent graph objects (i.e., instances of the husband class 424, the wife class 426, and the child class 428). Additionally, the class factory 422 also inherits deadlock detection and resolution functions from the concurrent graph base class 405.

In one embodiment, the code generator creates a derived class from the concurrent object base class 410 for each class described in the data schema. The source code generated for each such derived class encapsulates functionality allowing multiple threads to concurrently read, update, and delete objects in the concurrent graph data structure, as well as capture (and enforce) relationships between classes specified by the data schema 300. For example, the generated code will enforce the cardinality specified by a given relationship (e.g., an instance of the husband class can have a relationship to at most one instance of the wife class, but can be related to multiple instances of the child class). The generated classes 420 also includes any specific methods or procedures described by the data schema 300, along with an inherited collection of methods inherited from the concurrent object base class 410

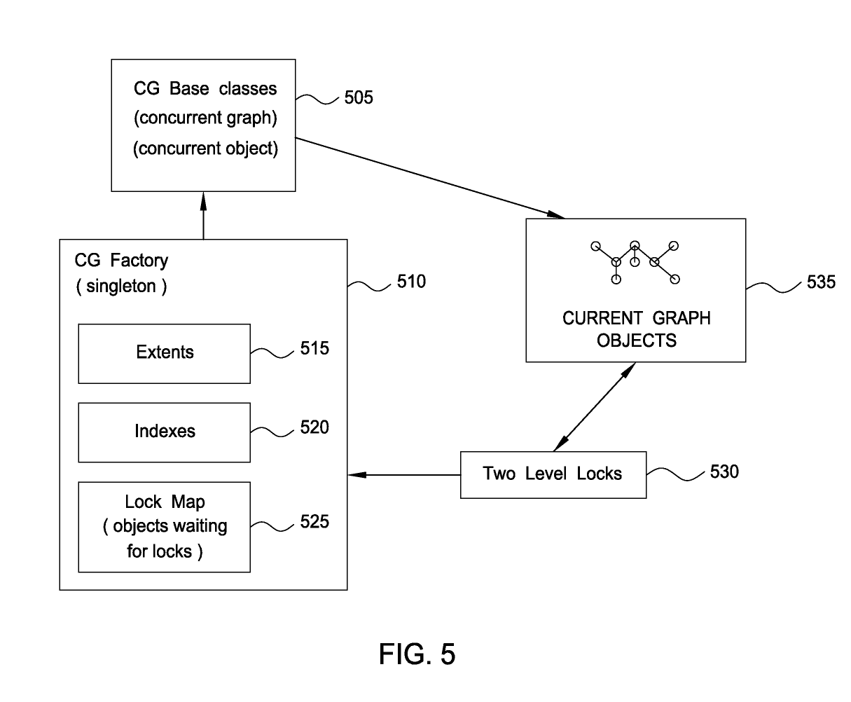

FIG. 5 further illustrates an example of a concurrent graph data structure used to provide an in-memory DBMS accessed by a multithreaded application, according to one embodiment. More specifically, FIG. 5 further illustrates the concurrent graph factory object 510 derived from the concurrent graph base class 505. Illustratively, the factory object 510 includes extents 515, indexes 520, and lock map 525. Once initialized by a multithreaded application, threads can create concurrent graph objects 535. Extents 515 provides a list of all instances of each class type created by the factory—e.g., all husband, wife, and child instances of the classes shown in FIG. 4 created by threads as part of a transaction with the in memory DBMS. The indexes 510 provide an index of the unique or key values for each class. Doing so allows the in memory database to quickly find an object reference based on a key value—as well as enforce key constraints when creating new graph objects 535 as part of thread transactions. While the indexes 520 may be implemented in a variety of ways, in one embodiment, the indexes 520 are implemented as a binary tree (BTREE).

The lock map 525 allows the factory object 510 to identify when a deadlock occurs and throw the appropriate exceptions in response. Doing so allows a thread requesting a lock that resulted in a deadlock condition to roll back and/or retry a given transaction. In one embodiment, concurrency issues are managed by the concurrent graph data structure using two level locks 530. In such an embodiment, a thread may obtain a lock to a given concurrent graph object 535 whenever a transaction is performed that includes that concurrent graph object 535. The two level locks 530 include one (or more) read locks for a given concurrent graph object 535 and a single write lock for that concurrent graph object 535. That is, multiple threads may obtain a read lock for a given concurrent graph object 535, but only one thread may obtain a write lock at any given time. When requesting a write lock, a thread performing a transaction needs to wait until all read locks on that object have been released and the write lock is then obtained, allowing the transaction to continue. Similarly, if a write lock is active for a given object, any thread requesting a read lock for that object needs to wait until the write lock for that object is released and the read lock is then obtained. The lock map 525 identifies what locks have been requested for a given object and what thread (or threads) is waiting for a given read or write lock. In the event of a deadlock, the concurrent graph factory object 510 can resolve the deadlock by throwing an exception caught by the threads causing the deadlock. In response, the threads can rollback a partially completed transaction causing it to release all of its locks, thus resolving the deadlock.

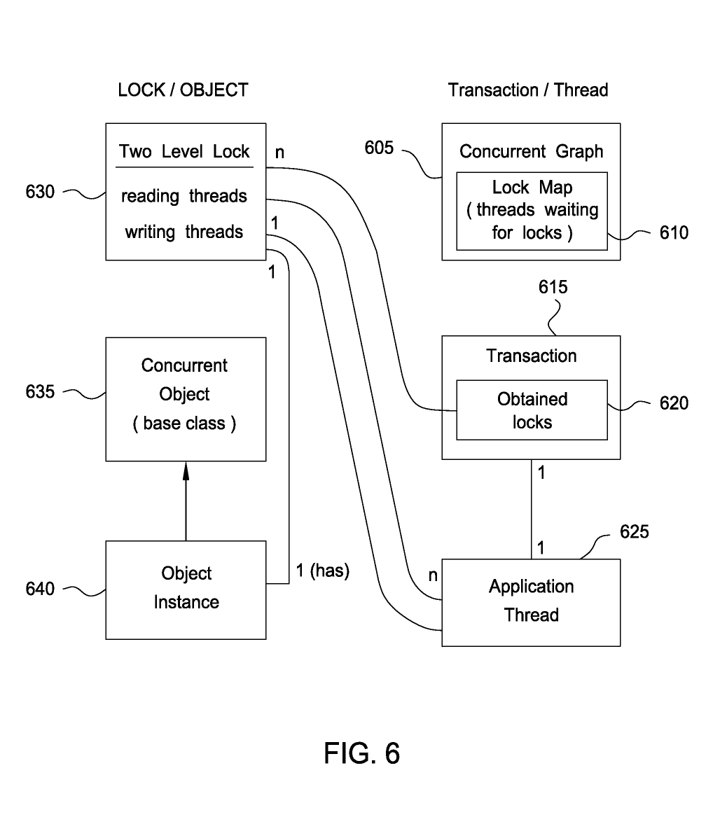

FIG. 6 further illustrates relationships between objects in the concurrent graph data structure and locks obtained by application thread performing a transaction, according to one embodiment. As shown, an application thread 625 can initiate at most one transaction 615 at any given time (and each transaction is associated with a single thread instance). Once a transaction 620 is initiated, the transaction 620 includes a set of zero or more obtained locks 620. Each obtained lock 620 is associated with a two level lock object 630. In turn, each object instance 640 has a 1:1 relationship with a single two-level lock object 630. That is, each instance 640 of a concurrent graph object has a single two-level lock 630 associated with it. The object instance 640 corresponds to an object derived from the concurrent object base class 635 and instantiated by the object factory of the concurrent graph data structure (as described above). Each lock 630 has either a writing thread or multiple reading threads associated with the lock (or no threads, meaning that object instance 640 is not locked by any thread and that both a read lock and a write lock is available). In addition to lock object 630, the concurrent graph data structure 605 maintains a lock map 610 used to identify deadlocks, as described above.

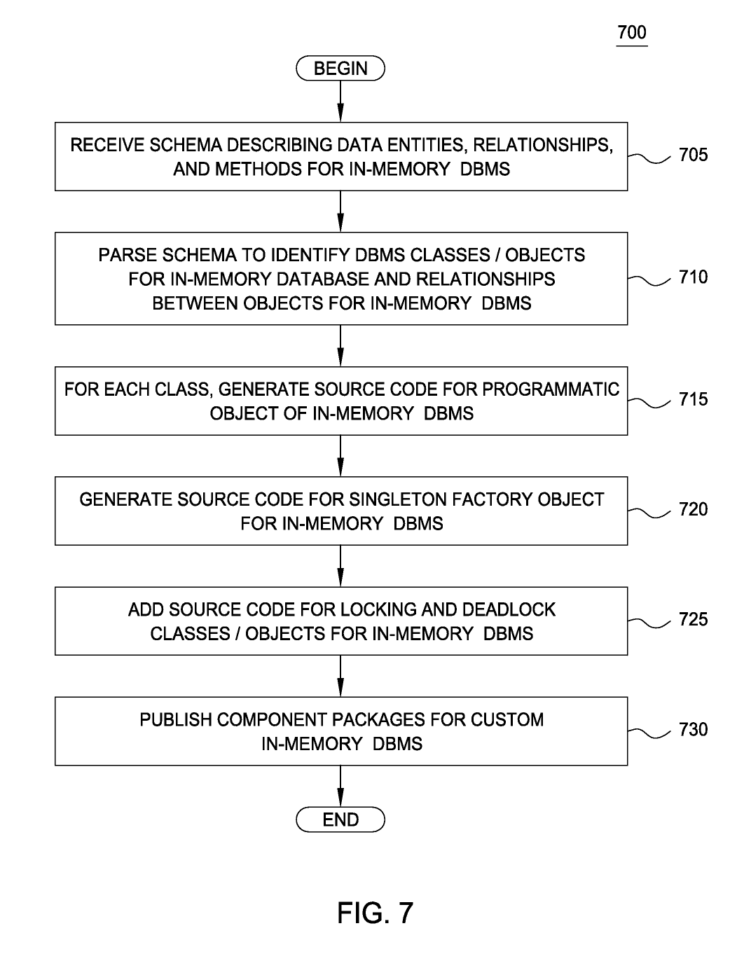

FIG. 7 illustrates a method 700 for generating source code for an in-memory DBMS from an application specific data schema, according to one embodiment. As shown, the method 700 begins at step 705, where a code generation tool receives a data schema for an in memory DBMS. As described above, the schema may specify a set of classes and attributes and methods for each class. Further the schema may specify a key value or unique attributes for each object instance along with relationships between objects. At step 710, the code generator parses the data schema to identify the classes for the in-memory database and the relationships between classes in the in-memory database.

At step 715, the code generator generates source code for each class identified in the data schema. For example, in one embodiment, the code generator may create a derived class from a concurrent object base class. Such a derived class may include the attributes, keys, and methods specified by the data schema for that class. Further, the derived class may include source code that allows the derived object to interact with the two level locks and the factory object. For example, in addition to any scheme specific methods, the code generator may create methods to access, read and write to the data attributes of that class. Importantly, the derived class includes code needed to obtain read/write locks automatically when methods to read or write to the attributes are invoked by an application thread as part of a transaction.

At step 720, the code generator generates source code for a factory object for the in-memory DBMS. As described above, in one embodiment, the factory object may be derived from a concurrent graph base class and provide the functionality needed to create instances of the object classes generated at step 715, as well as source code to identify and resolve deadlocks that occur when multiple threads access locks to objects in the in-memory database. Additionally, the factory object may include source code configured to create indexes and extents of objects created by the application threads as part of a transaction at runtime. The indexes allow object references to quickly and efficiently be obtained by an application thread and the extents allow an application thread to quickly identify all objects of a given object type. Further, the code generator may also include source code in the factory object for creating and maintain a map indicating what objects are waiting for a given object lock and include source code for resolving deadlocks when they occur.

At step 720, the code generator generates source code for the in memory database that does not depended on the contents of the data schema received at step 705. For example, the support classes may include the locking and deadlock objects described above as well as code used to persist (or restore) a concurrent graph data structure from non-volatile storage. At step 730, the code generator outputs the source code for the classes generated at steps 715, 720, and 725.

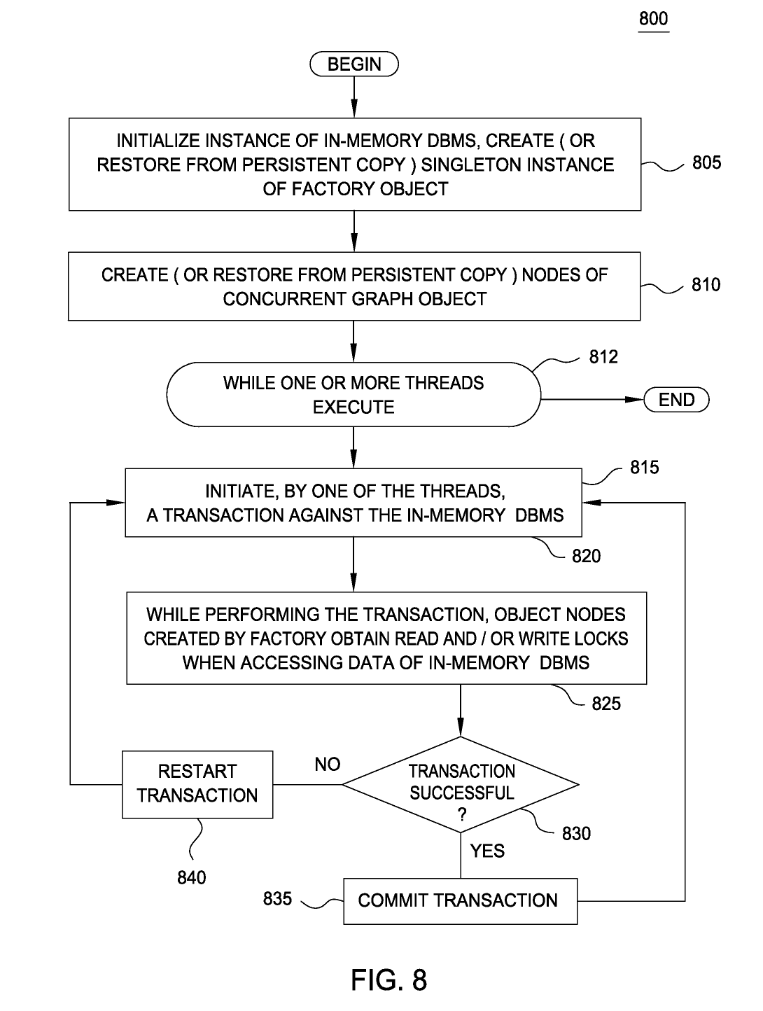

FIG. 8 illustrates a method 800 for performing transactions against an in-memory DBMS, according to one embodiment. As shown, the method 800 begins at step 805 where a user launches a multithreaded application configured to access an in-memory DBMS configured as a concurrent graph data structure. For example, the multithreaded application may restore the state of an in-memory DBMS persisted to storage or create a new instance of a concurrent graph data structure. In the latter case, e.g., the multithreaded application may create a singleton instance of an object factory class.

Once created (or resorted) multiple application threads may read to and write from object nodes in the concurrent graph data structure. As shown by method 800, e.g., a loop begins following block 812 where the multithreaded application selects a thread to execute (until it blocks) or relinquishes control. At step 815, a thread initiates (or resumes) a transaction. In the present context, a transaction refers to an operation performed against the in-memory DBMS that should either be committed or rolled back. While performing a transaction, e.g., while the thread invokes accessor and mutator methods for one of the concurrent objects, the concurrent objects obtain read and/or write locks when accessing data objects in the in-memory DBMS (step 825). At step 830, the thread determines whether a transaction has been successfully completed. If so, then the thread commits the transaction (step 835). Otherwise, if the transaction fails (e.g., because a deadlock occurs) any changes made by the transaction are rolled back, and the thread may restart the transaction (step 840). In either case, the method 800 returns to step 815 where another thread is executed (allowing another transaction to be resumed/initiated). For example, the following table illustrates an example pattern for a thread to perform a transaction using the Java programming language

TABLE I
Source code for Transaction pattern

```
// Example transaction in a client that accesses the ConcurrentGraph:
Factory cg = Factory.instrance( ) //get reference to singleton instance
of Factory
do {
    try {
        cg.start( );
        /* code that reads or writes database objects goes here */
        cg.commit( ); // cg.retry( ) will be false at this point
    } catch (RethrownDeadlockException rde) {
        cg.setRetryTrueInOuterTx(rde); //try again
        s_log.warn(“Deadlock: trying again: “ + rde.getrMessage( ) );
    } catch (DeadlockException de) {
        cg.setRetryTrueInOuterTx(de); //try again
        s_log.warn(“Deadlock: trying again: “ + de.getrMessage( ) );
    } finally {
        If (cg.needToRollbakInFinally ( )
            cg.rollback( ); //ensure all locks are released on exceptions
    }
  } while (cg.retry( ) );
```

The code between cg.start( ) and cg.commit( ) may throw exceptions that are not caught by the above pattern. In that case, a cg.rollback( ) will occur due to the finally clause. Thus, uncaught exceptions are considered to be errors that abort the transaction and all changes to the concurrent graph data structure will be rolled back if the uncaught exception passes through the transaction boilerplate. Another approach to provide this transaction pattern would be to use Java annotation semantics. For example, a “@begin_transaction” and an “@end_transaction” annotation could be used to hide the boilerplate code, allowing the developer to simply bracket their transactions with the annotations.

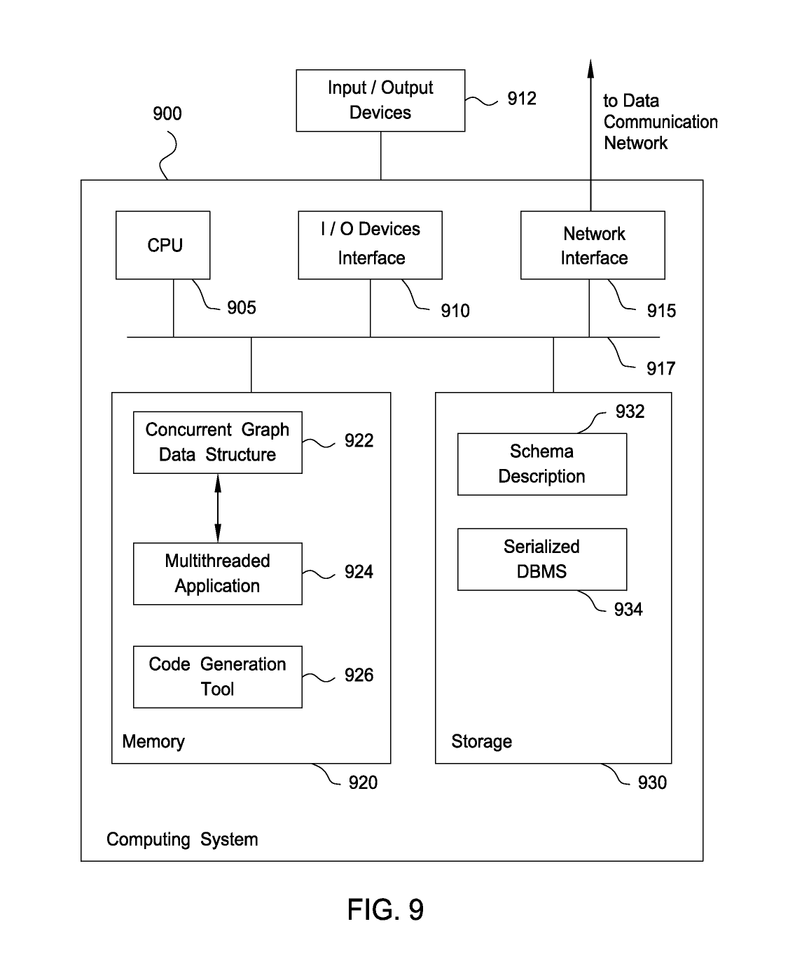

FIG. 9 illustrates an example computing system configured with a concurrent graph data structure, according to one embodiment. As shown, the computing system 900 includes, without limitation, a central processing unit (CPU) 905, a network interface 915, a network interface 915, a memory 920, and storage 930, each connected to a bus 917. The computing system 900 may also include an I/O device interface 910 connecting I/O devices 912 (e.g., keyboard, display and mouse devices) to the computing system 900. Further, in context of this disclosure, the computing elements shown in computing system 900 may correspond to a physical computing system (e.g., a system in a data center) or may be a virtual computing instance executing within a computing cloud. Similarly, computing system 900 is included to be representative of a variety of devices, e.g., a desktop or server computing system, a tablet device, a mobile phone, game console, etc.

The CPU 905 retrieves and executes programming instructions stored in the memory 920 as well as stores and retrieves application data residing in the storage 930. The interconnect 917 is used to transmit programming instructions and application data between the CPU 905, I/O devices interface 910, storage 930, network interface 915, and memory 920. Note, CPU 905 is included to be representative of a single CPU, multiple CPUs, a single CPU having multiple processing cores, and the like. And the memory 920 is generally included to be representative of a random access memory. The storage 930 may be a disk drive storage device. Although shown as a single unit, the storage 930 may be a combination of fixed and/or removable storage devices, such as fixed disc drives, removable memory cards, or optical storage, network attached storage (NAS), or a storage area-network (SAN).

Illustratively, the memory 920 includes a concurrent graph data structure 922, a multithreaded application 924, and a code generation tool 926. And the storage 930 includes a schema description 932 and persisted DBMS 934. As described above, the concurrent graph data structure 922 provides an in-memory DBMS accessed by the multithreaded application 924. At the same time, for the application developer, the objects of the concurrent graph data structure 922 are accessed using familiar semantics for creating, reading, updating, and deleting objects. That is, the developer may interact with the objects instantiated in the concurrent graph data structure as a collection of “plain old Java objects.” The code generation tool 926 is generally configured to create the classes needed for the concurrent graph data structure 922 from a schema description 932. The persisted DBMS 934 represents a serialized copy of the concurrent drag data structure written to disk 922. Note, while computing system 900 shows both the code generation tool and the concurrent graph data structure 922 on the same computing device, one of ordinary skill in the art will recognize that the code generation tool 924 need not be included or distributed with the multithreaded application 925.

As described, embodiments presented herein provide an object-oriented, multithreaded application program that both supports a specific object-schema and provides transactional semantics for threads launched by the application to access a concurrent graph data structure, which itself provides an in-memory DBMS for the application threads. Embodiments presented herein also provide techniques for generating source code for the concurrent graph data structure, transaction patterns for accessing the concurrent graph data structure, as well as source code for creating, reading and updating, and deleting attributes for objects in the graph structure. At the same time, the generated code handles concurrency issues and deadlocks that occur when multiple threads access the concurrent graph data structure.

While the foregoing is directed to embodiments of the present invention, other and further embodiments of the invention may be devised without departing from the basic scope thereof, and the scope thereof is determined by the claims that follow.

What is claimed is:

1. A method for generating source code for a concurrent graph in-memory database management system (DBMS), the method comprising:
receiving a schema description of a concurrent graph data structure, wherein the schema description specifies one or more concurrent object classes, relationships among the one or more object classes, and at least a primary key used to identify instance of each of the one or more object classes;
generating, for each of the one or more concurrent object classes, source code implementing the one or more concurrent object class as specified by the schema description;
generating, for the concurrent graph data structure, source code implementing an object factory class, wherein the object factory class is configured to instantiate instances of the one or more object classes in response to requests from a thread in the multithreaded application; and
generating, for the in-memory DBMS, source code to provide concurrency control to each instance of the one or more object classes instantiated by the object factory in the concurrent graph data structure.

2. The method of claim 1, further comprising, packaging the generated source code implementing the one or more concurrent object classes, the source code implementing the object factory class, and the source code to provide the concurrency control in a source code package.

3. The method of claim 1, wherein the concurrency control is maintained via a two-level lock, including a read lock and a write lock for each instantiated instance of the one or more object classes, wherein multiple concurrent read locks may be obtained by threads of the multithreaded application and only a single write lock may be obtained by the threads during execution of the multithreaded application.

4. The method of claim 1, further comprising, generating a transaction pattern for an application thread to perform a transaction against the instantiated instances of the one or more object classes.

5. The method of claim 4, wherein the transaction pattern identifies an atomic work unit for the concurrent graph data structure.

6. The method of claim 1, wherein the object factory class includes source code for maintaining a map of threads waiting for a lock associated with one of the instances of the one or more objects instantiated by the multithreaded application.

7. The method of claim 1, wherein the schema description further specifies source code for a method for at least one of the one or more concurrent object classes.

8. The method of claim 1, wherein the object factory class includes source code for resolving deadlocks occurring between two or more threads waiting for a lock associated with two or more instances of the one or more object classes instantiated by the multithreaded application.

9. A computer-readable storage medium storing instructions, which, when executed on a processor, performs an operation for generating source code for a concurrent graph in-memory database management system (DBMS), the operation comprising:
receiving a schema description of a concurrent graph data structure, wherein the schema description specifies one or more concurrent object classes, relationships among the one or more object classes, and at least a primary key used to identify instance of each of the one or more object classes;
generating, for each of the one or more concurrent object classes, source code implementing the one or more concurrent object class as specified by the schema description;
generating, for the concurrent graph data structure, source code implementing an object factory class, wherein the object factory class is configured to instantiate instances of the one or more object classes in response to requests from a thread in the multithreaded application; and
generating, for the in-memory DBMS, source code to provide concurrency control to each instance of the one or more object classes instantiated by the object factory in the concurrent graph data structure.

10. The computer-readable storage medium of claim 9, wherein the operation further comprises, packaging the generated source code implementing the one or more concurrent object classes, the source code implementing the object factory class, and the source code to provide the concurrency control in a source code package.

11. The computer-readable storage medium of claim 9, wherein the concurrency control is maintained via a two-level lock, including a read lock and a write lock for each instantiated instance of the one or more object classes, wherein multiple concurrent read locks may be obtained by threads of the multithreaded application and only a single write lock may be obtained by the threads during execution of the multithreaded application.

12. The computer-readable storage medium of claim 9, wherein the operation further comprises, generating a transaction pattern for an application thread to perform a transaction against the instantiated instances of the one or more object classes.

13. The computer-readable storage medium of claim 12, wherein the transaction pattern identifies an atomic work unit for the concurrent graph data structure.

14. The computer-readable storage medium of claim 9, wherein the object factory class includes source code for maintaining a map of threads waiting for a lock associated with one of the instances of the one or more objects instantiated by the multithreaded application.

15. The computer-readable storage medium of claim 9, wherein the schema description further specifies source code for a method for at least one of the one or more concurrent object classes.

16. The computer-readable storage medium of claim 9, wherein the object factory class includes source code for resolving deadlocks occurring between two or more threads waiting for a lock associated with two or more instances of the one or more object classes instantiated by the multithreaded application.

17. A system, comprising:
a processor and
a memory hosting an code generation tool, which, when executed on the processor, performs an operation for generating source code for a concurrent graph in-memory database management system (DBMS), the operation comprising:
receiving a schema description of a concurrent graph data structure, wherein the schema description specifies one or more concurrent object classes, relationships among the one or more object classes, and at least a primary key used to identify instance of each of the one or more object classes,
generating, for each of the one or more concurrent object classes, source code implementing the one or more concurrent object class as specified by the schema description,
generating, for the concurrent graph data structure, source code implementing an object factory class, wherein the object factory class is configured to instantiate instances of the one or more object classes in response to requests from a thread in the multithreaded application, and
generating, for the in-memory DBMS, source code to provide concurrency control to each instance of the one or more object classes instantiated by the object factory in the concurrent graph data structure.

18. The system of claim 17, wherein the operation further comprises, packaging the generated source code implementing the one or more concurrent object classes, the source code implementing the object factory class, and the source code to provide the concurrency control in a source code package.

19. The system of claim 17, wherein the concurrency control is maintained via a two-level lock, including a read lock and a write lock for each instantiated instance of the one or more object classes, wherein multiple concurrent read locks may be obtained by threads of the multithreaded application and only a single write lock may be obtained by the threads during execution of the multithreaded application.

20. The system of claim 17, wherein the operation further comprises, generating a transaction pattern for an application thread to perform a transaction against the instantiated instances of the one or more object classes.

21. The system of claim 20, wherein the transaction pattern identifies an atomic work unit for the concurrent graph data structure.

22. The system of claim 17, wherein the object factory class includes source code for maintaining a map of threads waiting for a lock associated with one of the instances of the one or more objects instantiated by the multithreaded application.

23. The system of claim 17, wherein the schema description further specifies source code for a method for at least one of the one or more concurrent object classes.

24. The system of claim 17, wherein the object factory class includes source code for resolving deadlocks occurring between two or more threads waiting for a lock associated with two or more instances of the one or more object classes instantiated by the multithreaded application.
